(19) United States
(12) Patent Application Publication
(10) Pub. No.: US 2026/0298763 A1
(43) Pub. Date: Oct. 1, 2026

(54) FOUP GASTIGHTNESS DETECTION DEVICE AND METHOD THEREOF

(71) Applicant: ASIA NEO TECH INDUSTRIAL CO., LTD., TAOYUAN CITY (TW)

(72) Inventor: PU-CHANG YEH, TAOYUAN CITY (TW)

(21) Appl. No.: 19/291,536

(22) Filed: Aug. 5, 2025

Related U.S. Application Data
(60) Provisional application No. 63/781,398, filed on Apr. 1, 2025.

(51) Int. Cl. G01M 3/32

(52) U.S. Cl. CPC G01M 3/3209

(57) ABSTRACT

A FOUP gastightness detection device and method is disclosed, comprising filling a gas at a specific pressure into the chamber of the FOUP formed by a shell and a door for pressure accumulation, and then measuring a judgment factor of the gas with accumulated pressure within the chamber to detect the gastightness of the chamber. When an abnormal gastightness of the chamber is detected, a standard door without leakage factors is used to replace the door, so as to determine whether the leakage causing the gastightness abnormality is from the shell or the door. In this way, the specific leaking part of the FOUP can be replaced or repaired to recover good gastightness.

### BACKGROUND OF INVENTION

### 1. Field of the Invention

The present invention relates generally to gastightness detection for front-opening unified pod (FOUP), and more particularly to a FOUP gastightness detection device and method thereof.

### 2. Description of Related Art

Currently, front-opening unified pods (FOUPs) are mainly used to carry items such as wafers, carriers, or panels for necessary process manufacturing. It is known that, according to process requirements, the interior of a FOUP often needs to be filled with gases such as nitrogen (N2). Therefore, the gastightness of the FOUP must be maintained above a certain standard to ensure the process quality of the items carried inside.

As shown in FIG. 1a, the prior-art FOUP 10 is composed of a shell 11 with an internal chamber 13, and a door 12 locked to the shell 11. A sealing rubber strip 14 is assembled on the periphery of the door 12 to seal the chamber 13 when the door 12 is locked onto the shell 11. Ideally, this prevents gas from seeping into or leaking out of the chamber 13. However, in practice, aging or damage of the sealing rubber strip 14 may result in reduced gastightness of the chamber 13. Additionally, the structural configuration on the shell 11 and door 12 may also pose risks of affected gastightness of the chamber 13.

Further, as shown in FIG. 1a, the outer wall of the shell 11 has a plurality of screw holes 111 for screws 15 to pass through and lock onto the inner wall of the chamber 13. In addition, FIG. 1b shows that, apart from having a pair of exhaust valve ports 112 and a pair of gas inlet valve ports 113, the bottom of the shell 11 also has a plurality of screw holes 114 for screws 16 to pass through and lock onto the inner wall of the chamber. Since the shell 11 and the chamber 13 need to be locked with some functional components using said screws 15, 16 and screw holes 111, 114, the functional components at least include row-shaped guiding ribs 17 installed on both sides of the inner wall of the chamber. When the screws 15, 16 pass through the screw holes 111, 114, a gas-stopping gasket (not shown in the figure) is generally sleeved on them to prevent the gas inside the chamber 13 from leaking out of the FOUP 10 through these screw holes 111, 114.

Based on said structural configuration of the prior-art FOUP, the present invention focuses on exploring the factors causing poor gastightness (i.e., gas leakage) of the FOUP 10, including:
1. Regarding the shell 11, the gastightness of the FOUP 10 may be affected due to the aging or damage of the one-way check valve components installed in the gas outlet valve ports 112 and the gas inlet valve ports 113, the aging or damage of the gas-stopping gaskets sleeved in the screw holes 111, 114, or the cracking of the shell 11; and
2. Regarding the door 12, the gastightness of the FOUP 10 may be affected due to the aging or damage of said sealing rubber strip 14, or the deformation or cracking of the door 12.

Among the prior-art techniques aiming to overcome the above problems that can affect the gastightness of the FOUP 10, Patent WO2018083312A1 provides the closest features. This patent teaches a technology for gastightness detection of the FOUP 10, which includes injecting gas into the sealed FOUP chamber through the gas inlet valve ports 113 of the FOUP 10 and blocking the gas outlet valve ports 112 of the FOUP 10 to detect the quality of the gastightness after the door 11 and the shell 12 of the FOUP are locked to each other.

However, this patent can only detect whether the FOUP 10 has gas leakage or whether the leakage flow exceeds the established standard. It cannot determine the actual location of the gas leakage in the FOUP 10. In other words, this patent cannot determine whether the gas inside the chamber 13 leaks out due to said problems of the shell 11 or the door 12. As a result, in the process of maintaining the yield rate of FOUPs 10 on the production line, manufacturers cannot determine the location of the gas leakage in the FOUP 10 for repair or replacement (such as replacing the door or the shell). Replacing the entire FOUP will obviously increase the cost burden of the manufacturers. Therefore, an improvement is urgently needed.

### SUMMARY OF THE INVENTION

In view of the technical problems to be solved in the prior art, the present invention aims to provide a FOUP gastightness detection device and method to detect whether the actual leakage position of the FOUP 10 shown in FIG. 1a and FIG. 1b occurs in the shell 11 or the door 12, thereby facilitating maintenance or replacement of the leaking shell 11 or door 12. The FOUP gastightness detection device of the present invention includes a pressure accumulation gas loop, a gas sensor, and a standard door that has eliminated leakage factors. Specifically, the pressure accumulation gas loop is configured to guide gas through at least two valve ports into the chamber to form a closed loop; the gas sensor is serially connected in the pressure accumulation gas loop to capture a judgment factor of the gas within the pressure accumulation gas loop, thereby detecting the gastightness of the chamber; and the standard door is movably configured within the detection device; Specifically, when the gas sensor detects an abnormal gastightness in the chamber, the standard door is used to replace the door to check if the leakage causing the abnormal gastightness is from the shell or the door.

In a further embodiment, the valve ports include at least one gas inlet valve port and at least one gas outlet valve port. The pressure accumulation gas loop includes an intake duct connected between a gas supply end and at least one gas inlet valve port. The detection device further includes at least one gaslock component to seal the at least one gas outlet valve port and to transform the pressure accumulation gas loop into a closed loop.

The pressure accumulation gas loop includes an intake duct and an exhaust duct. The intake duct is connected between the gas supply end and at least one gas inlet valve port, while the exhaust duct is connected between at least one gas outlet valve port and an exhaust port. The detection device further includes a gaslock component to seal the exhaust port and transform the pressure accumulation gas loop into a closed loop.

In a further embodiment, the gas sensor is serially connected between the gas supply end and the at least one gas inlet valve ports via the intake duct. Alternatively, the gas sensor is serially connected between the exhaust port and the at least one gas outlet valve port via the exhaust duct, and the gas sensor is a pressure sensor capable of detecting the pressure value of the gas within the chamber. Or, the gas sensor is serially connected between the gas supply end and the at least one gas inlet valve port via the intake duct, and the gas sensor is a flow controller (or flow detector) capable of detecting the gas flow within the chamber.

In a further embodiment, the intake duct communicates with at least one gas inlet valve port via a sealing element. The sealing element is driven by a first actuator to achieve gastight connection and communication with the at least one gas inlet valve ports. The gaslock component is driven by a second actuator to seal the exhaust port.

In a further embodiment, the standard door and the door are driven by at least one third actuator to enable replacement of the door with the standard door.

Additionally, the FOUP gastightness detection method of the present invention includes filling a gas at a specific pressure through at least one valve port into the chamber to form a closed loop, and then measuring a judgment factor of the accumulated gas within the chamber to check its gastightness. When abnormal gastightness is detected, a standard door without leakage factors is used to replace the door, and the judgment factor measured after gas accumulation is used to judge whether the leakage is from the shell or the door.

Compared to prior art, through the above implementations, the present invention can precisely judge if the leakage of the FOUP occurs in the door, shell, or its components. The leaking door, shell or component can be individually replaced. This will help improve gastightness stability of FOUPs in production lines and can avoid unnecessary costs from replacing the entire FOUP with leakage detected.

The above disclosed implementation and technical effects will be further described in detail using the following figures and embodiments.

### BRIEF DESCRIPTION OF THE DRAWINGS

FIG. 1a is an exploded perspective view of a prior-art FOUP, disclosing that the FOUP comprises a shell and a door locked to the shell.

FIG. 1b is a bottom view of the shell shown in FIG. 1a, disclosing that the bottom of the shell is provided with at least two valve ports connected to the chamber.

FIG. 2 is a sectional view of the configuration of a first embodiment of the detection device of the present invention, disclosing that the pressure accumulation gas loop of the detection device is established between the intake duct and the chamber to measure the judgment factor for judging whether the gastightness is good or not.

FIG. 3 is an operational view illustrating the establishment of the pressure accumulation gas loop by the detection device shown in FIG. 2.

FIG. 4 is an operational view illustrating the replacement of the door of the FOUP with a standard door through the detection device shown in FIG. 2.

FIG. 5 is a sectional view of the configuration of a second embodiment of the detection device of the present invention, disclosing that the pressure accumulation gas loop of the detection device is established between the intake duct, the chamber, and the exhaust duct to measure the judgment factor for judging whether the gastightness is good or not.

FIG. 6 is an operational view illustrating the establishment of the pressure accumulation gas loop through the detection device shown in FIG. 5.

FIG. 7 is a block diagram illustrating the execution procedure of the detection method of the present invention.

### DETAILED DESCRIPTION OF THE INVENTION

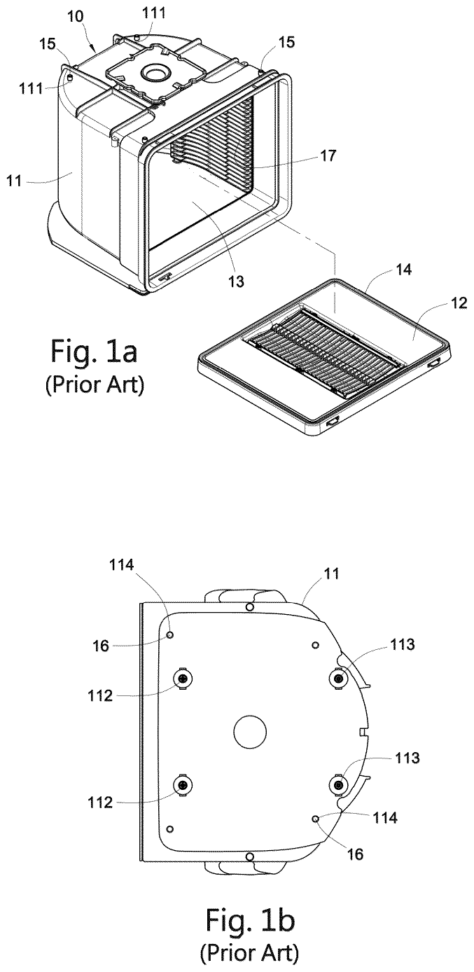

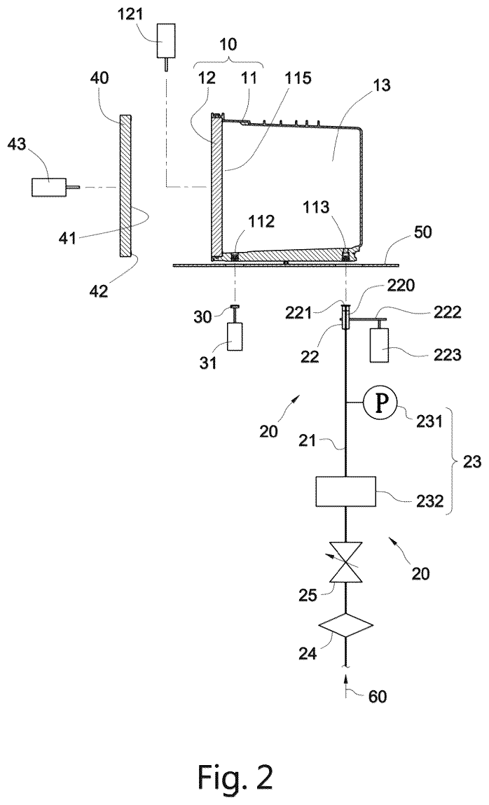

First, please refer to FIG. 2 to FIG. 4 together. A detection device according to the first embodiment of the present invention is disclosed, which is used to detect the gastightness of the chamber 13 of the FOUP 10 (including the shell 11 and the door 12) shown in FIG. 1a and FIG. 1b.

As can be seen from FIG. 1a, the FOUP 10 includes a shell 11 forming the chamber 13 and a door 12 for closing and sealing the chamber 13. The shell 11 has at least two valve ports that can control the time of communication between the chamber 13 and the external environment. As can be seen from FIG. 1b, the at least two valve ports include a pair of gas inlet valve ports 113 and a pair of gas outlet valve ports 112. In practice, there can be only one gas inlet valve port 113 and one gas outlet valve port 112. It is not necessary to have them in pairs. Moreover, the gas inlet valve port 113 is composed of an intake check valve that can control the entry of external gas into the chamber 13 without reflux, and the gas outlet valve port 112 is composed of an exhaust check valve that can control the discharge of gas from the chamber 13 to the outside without reflux.

As shown in FIG. 2, the detection device includes a platform 50 for placing the FOUP 10. The FOUP 10 can be placed on the platform 50 in a form where the door 12 closes an opening 115 of the shell 11 to close the chamber 13. The platform 50 can be a platform on top of a load port for loading and unloading the FOUP 10, or a work platform for placing the FOUP 10. To be more specific, the detection device can be directly configured inside the load port or the work platform having the platform 50. The detection device includes a pressure accumulation gas loop 20, a gas sensor 23, and a standard door 40 without leakage factors, configured through the platform 50. Specific features are as follow:

In the example shown in FIG. 2, the pressure accumulation gas loop 20 includes an intake duct 21 connected between a gas supply end 60 and at least one of the gas inlet valve ports 113. The gas supply end 60 can be a gas pump or a gas compressor. The intake duct 21 can be composed of a soft or hard pipe capable of guiding gas, and is connected to a sealing element 22 to communicate with at least one of the gas inlet valve ports. Specifically, the sealing element 22 is in the shape of a tube cover, having a ventilation hole 220 in the center and a gas connection nozzle 221 at the top. The ventilation hole 220 can communicate between the intake duct 21 and the gas connection nozzle 221, and the sealing element 22 is arranged adjacent to the outside of at least one of the gas inlet valve ports 113 of the shell 11. The sealing element 22 covers and seals at least one of the gas inlet valve ports 113 of the shell 11 when appropriate through the gas connection nozzle 221, so that the ventilation hole 220 can guide the gas to push open the check valve in at least one of the gas inlet valve ports 113, and then introduce the gas into the chamber 13. Furthermore, the sealing element 22 is arranged upright on a linkage arm 222, and the linkage arm 222 is movably connected to a first actuator 223. The first actuator 223 can be a pneumatic cylinder or other transmission device capable of performing reciprocating linear motion.

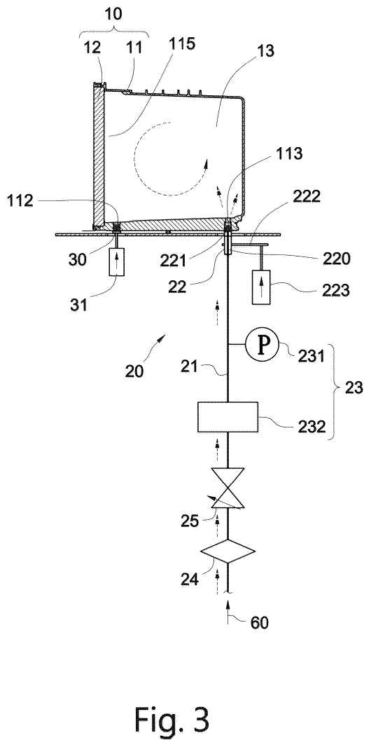

With this configuration, as shown in FIG. 3, the sealing element 22 can be driven by the first actuator 223 to cover and seal the gas inlet valve port 113 of the shell 11 in an gastight manner when appropriate, so that the pressure accumulation gas loop 20 can be constructed into a closed loop by the intake duct 21 and the space of the chamber 13. Then, by means of the pressure accumulation gas loop 20, a gas with a specific pressure is guided to enter the chamber 13 through the sealing element 22 communicating with at least one of the gas inlet valve ports 113 for pressure accumulation. In addition, the sealing element 22 can also be driven by the first actuator 223 to reset and release the gas inlet valve port 113 (as in the state of FIG. 2).

In the example shown in FIG. 2, the detection device can also include at least one gaslock component 30 composed of a plug body capable of blocking gas passage, which is used to close at least one of the gas outlet valve ports 112. The way for the gaslock component 30 to close the gas outlet valve port 112 can be manual plugging, or, according to the example shown in FIG. 2, the gaslock component 30 is driven by a second actuator 31 to close at least one of the gas outlet valve ports 113, so that the intake duct 21 and the space of the chamber 13 can truly form the closed loop. Accordingly, as shown in FIG. 3, before measuring the gas pressure in the chamber 13, at least one of the gaslock components 30 can be used to forcibly close the gas outlet valve port 112, so that the gas in the chamber 13 can be concentrated to the specific pressure, and the gas introduced into the chamber 13 for pressure accumulation is prevented from leaking to the outside through the gas outlet valve port 112. In addition, the gaslock component 30 can also be driven by the second actuator 31 to reset and release the gas outlet valve port 112 (as in the state of FIG. 2).

In FIG. 3, the dotted arrows indicate the flow path of the gas, the solid arrows indicate the transmission directions of the first actuator 223 and the second actuator 31, and both the first actuator 223 and the second actuator 31 can be made of power cylinders such as pneumatic or hydraulic cylinders, or made of push rods driven by a worm bolt or a motor to perform reciprocating motion.

In the examples shown in FIG. 2 and FIG. 3, the gas sensor 23 can be a pressure sensor 231 capable of detecting the pressure value of the gas in the chamber 13, or a flow controller 232 (or called a flow detector) capable of detecting the gas flow in the chamber 13. In practice, the pressure sensor 231 and the flow controller 232 can be connected in series between the gas supply end 60 and the sealing element 22 through the intake duct 21, so as to timely capture at least one of the pressure value and the flow rate of the gas in the chamber 13 through the pressure accumulation gas loop 20, which is used as a judgment factor for the present invention to judge the gastightness of the FOUP 10. Specifically, the gas can be one of air, nitrogen, and ultra-pure compressed dry air (XCDA), all of which are gases applicable to the present invention.

In addition, as shown in FIG. 2, the gas pipeline 20 can also be connected in series with a particulate filter 24 and a pressure reducer 25 between the gas supply end 60 and at least one of the gas sensors 23 through the intake duct 21. The particulate filter 24 can filter the particles in the gas to purify the gas introduced into the chamber 13. The pressure reducer 25 can cooperate with the pressure sensor 231 to control a specific pressure of the gas injected into the chamber 13. Furthermore, as shown in FIG. 3, when the gas supply end 60 continuously guides the gas into the chamber 13, the pressure sensor 231 can detect the gas pressure. When the gas pressure is greater than the specific pressure, the pressure can be timely relieved through the pressure reducer 25 to maintain the gas in the chamber 13 at a constant specific pressure.

In the present invention, the standard door 40 without leakage factors means a door having the same gastight end face 41 as the aforementioned door 12 and a sealing rubber strip 42 installed on the gastight end face 41 to close and seal the opening 115 of the chamber 13 (as shown in FIG. 2). Moreover, the standard door 40 will not cause the gas in the chamber 13 to leak due to factors such as aging of the sealing rubber strip 42, deformation or damage of the cover body. More specifically, the standard door 40 can be a metal, non-metal or plastic imitation door imitating the shape and structure of the door, or a brand-new door without leakage factors. In other words, the difference between the standard door 40 and the aforementioned door 12 is that, the aforementioned door 12 is a door used in the production line with possible leakage factors, while the standard door 40 is a door that has not been used in the production line and is preset by the equipment end to eliminate leakage factors.

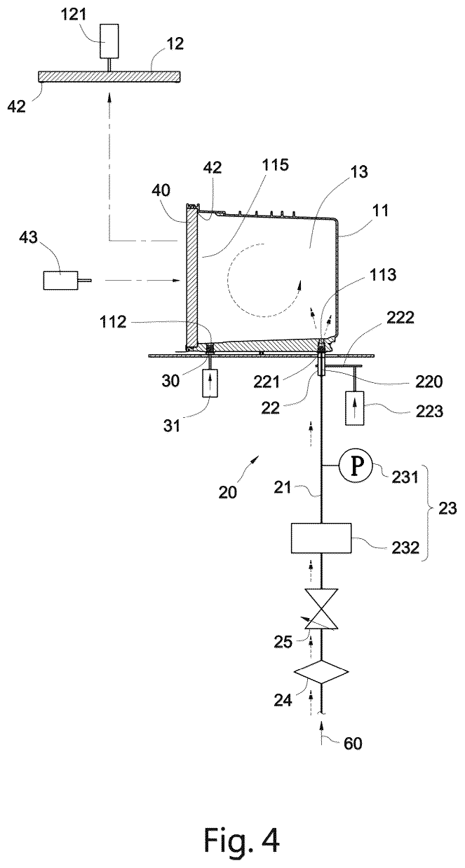

In the examples shown in FIG. 2 and FIG. 3, the standard door 40 can be movably configured in the detection device. When the gas sensor 23 detects an abnormality in the gastightness of the chamber 13, the door 12 can be replaced by the standard door 40 (as shown in FIG. 4) to judge whether the leakage causing the abnormal gastightness is from the shell 11 or the door 12 (to be described in detail later).

Specifically, the so-called “movably configured” means that the standard door 40 can be manually placed in the detection device to facilitate manual access to the standard door 40. Then, the door 12 on the shell 11 is manually unlocked and removed, and then the standard door 40 is manually locked on the shell 11 to replace the door 12. The so-called “movably configured” can also mean that a third actuator 121 and a fourth actuator 43 are configured in the detection device (as shown in FIG. 2 and FIG. 4).

Specifically, as shown in the example of FIG. 4, the third actuator 121 is used to drive the door 12, so that the door 12 can be unlocked from the shell 11 and moved away from the opening 115. The fourth actuator 41 is used to drive the standard door 40, so that the standard door 40 can be automatically combined with and locked on the shell 11 to close and seal the opening 115 of the chamber 13, so that the judgment factor of the pressure-accumulated gas in the chamber 13 can be measured. Further, the third actuator 121 and the fourth actuator 41 can be made of automatic machines with single-axis or multi-axis movement capabilities. Therefore, in practice, the operation of replacing the door 12 with the standard door 40 on the shell 11 can be realized only by using the third actuator 121 with multi-axis movement capabilities to drive the standard door 40 and the door 12 together.

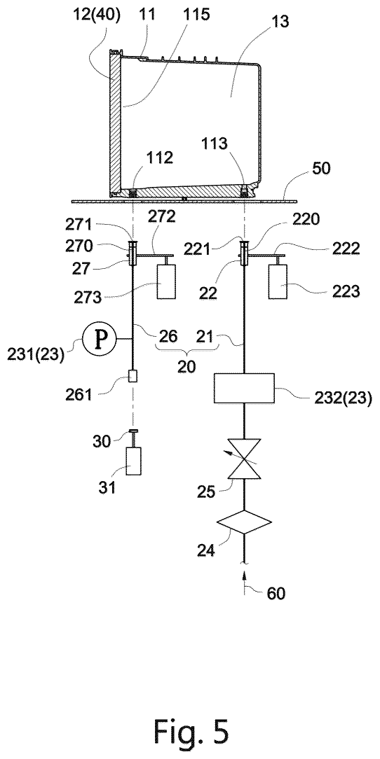

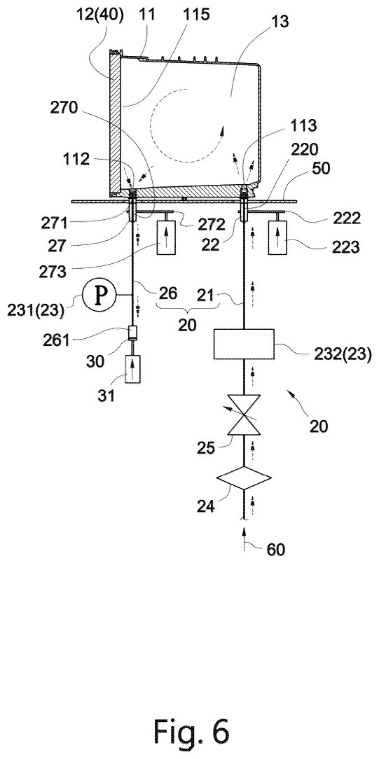

Next, please refer to FIG. 5 and FIG. 6 together. A detection device according to the second embodiment of the present invention is disclosed, which is used to detect the gastightness of the chamber 13 of the FOUP 10 (including the shell 11 and the door 12) shown in FIG. 1a and FIG. 1b.

As shown in FIG. 5, the difference between this example and the first embodiment shown in FIG. 2 is that, in addition to said intake duct 21 and the space of the chamber 13, the pressure accumulation gas loop 20 also includes an exhaust duct 26 communicating with the space of the chamber 13. More specifically, the exhaust duct 26 can be connected between at least one of the gas outlet valve ports 112 and an exhaust port 261. One end of the exhaust duct 26 can timely cover and seal the gas outlet valve port 112 through another sealing element 27. The sealing element 27 is also arranged upright on a linkage arm 272 and is driven by a fifth actuator 273 to cover and seal the gas outlet valve port 112 (as shown in FIG. 6). The sealing element 27 also has a central ventilation hole 270 and a gas connection nozzle 271 at the top that can cover and seal the gas outlet valve port 112. Therefore, the structure of the sealing element 27 is substantially similar to the aforementioned sealing element 22 located on the intake duct 25. Therefore, when the pressure-accumulated gas in the chamber 13 pushes open the exhaust check valve in the gas outlet valve port 112, the gas can be guided into the exhaust duct 26 through the ventilation hole 270 of the sealing element 27.

In the implementation shown in FIG. 5, the gaslock component 30 is used to close the exhaust port 261 of the exhaust duct 26, so that a closed loop for gas pressure accumulation is formed among the intake duct 21, the chamber 13 and the exhaust duct 26. More specifically, the gaslock component 30 can close the exhaust port 261 by manual plugging or through the drive of the second actuator 31 shown in FIG. 5 (as shown in FIG. 6) to construct and form the closed loop. The exhaust port 261 of the exhaust duct 26 is not absolutely necessary. In other words, the end of the exhaust duct 26 can also be made in a closed form to construct and form the closed loop, and it is not necessary to implement the paired combination of the exhaust port 261 and the gaslock component 30. All such variations belong to the application scope of the present invention.

In addition, the gas sensor 23 is connected in series between the exhaust port 261 and at least one of the gas outlet valve ports 112 through the exhaust duct 26, and the gas sensor 23 is the pressure sensor 231 capable of detecting the pressure value of the gas in the chamber. In other words, in addition to being configured in the intake duct 21 of the pressure accumulation gas loop 20 (as in the example shown in FIG. 2), the pressure sensor 231 can also be configured in the exhaust duct 26 of the pressure accumulation gas loop 20 (as in the example shown in FIG. 5). All such variations belong to the applicable technical scope of the present invention. The pressure accumulation gas loop 20 sequentially includes the intake duct 21, the space of the chamber 13 and the exhaust duct 26. In addition, the configuration techniques of the door 12, the standard door 40, etc. in the example shown in FIG. 5 are the same as those in the example shown in FIG. 2.

It must be mentioned that, in the example of FIG. 5, the intake duct 21 also includes the particulate filter 24, the pressure reducer 25 and the flow controller 232 connected in series between the gas supply end 60 and the flow controller 232, and the gas sensor 23 can also be the flow controller 232.

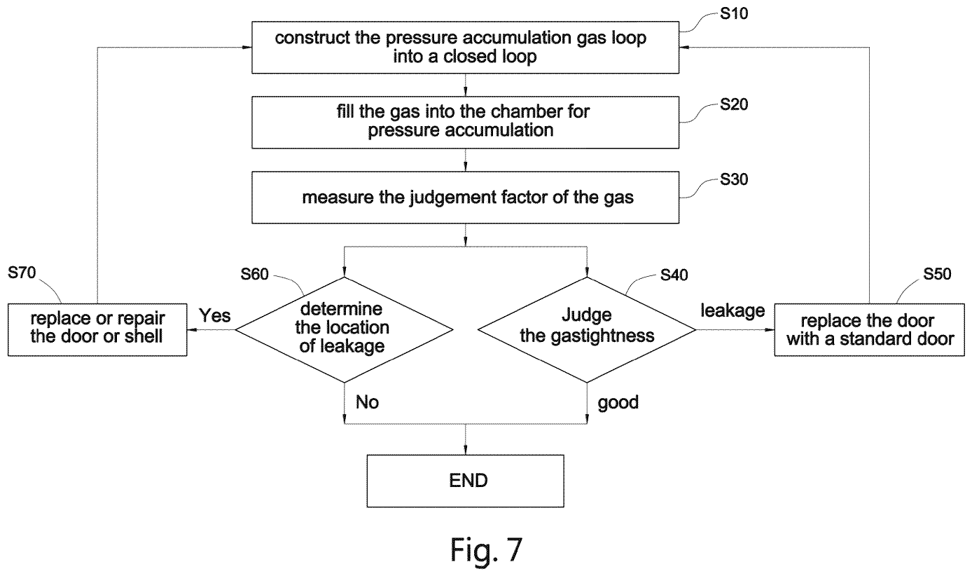

Further, based on said configuration techniques of the detection device, the present invention can execute a FOUP gastightness detection method for judging whether the leakage position of the FOUP 10 is in the shell 11 or the door 12. Please refer to FIG. 7. The detection method of the present invention is disclosed, which includes the following steps S10 to S70:
Step S10: Construct the pressure accumulation gas loop into a closed loop.

Based on the examples shown in FIG. 2 to FIG. 4, in this step, the sealing element 22 can be driven by the first actuator 223 shown in FIG. 3 to cover and seal the gas inlet valve port 113, and the gaslock component 30 can be driven by the second actuator 31 to block the gas outlet valve port 112 of the shell 11, so that the pressure accumulation gas loop 20 becomes a closed loop without gas leakage to the outside. Now, the preconditions for executing the following step S20 are ready.
Step S20: Fill the gas into the chamber for pressure accumulation.

In this step, a gas with a specific pressure (for example, 800 Pa) can be guided from the gas supply end 60 through the intake duct 21 of the pressure accumulation gas loop 20 shown in FIG. 3. The gas sequentially passes through the particulate filter 24, the pressure reducer 25, the flow controller 232, the pressure sensor 231, and the ventilation hole 221 of the sealing element 22, and then pushes open the intake check valve in the gas inlet valve port 113, so that the gas with a specific pressure can be filled into the chamber 13. The gas can be quickly concentrated in the chamber 13 to reach a pressure of 800 Pa or higher, to become the gas to be measured. Then, the following Step S30 can be performed.
Step S30: Measure the judgement factor of the gas

Please continue to refer to Table 1. As disclosed, in this step, the pressure sensor 231 in the pressure accumulation gas loop 20 shown in FIG. 3 can measure the pressure value of the gas as the judgement factor. As shown in Table 1, the specific pressure of the gas introduced into the FOUP 10 is assumed to be 800 Pa, and the measured pressure value is 350~700 Pa. The gas pressure values can be used as the judgement factor of the present invention for execution of the following Step S40.

TABLE 1
[Using the gas pressure value to judge the leakage position of the FOUP]

| | | Test 2 | | Test 3 | |
|---|---|---|---|---|---|
| | | shell closed | | shell closed | |
| pressure value of the | Test 1 | | replace | | replace |
| gas filled into the | shell closed | | standard | | standard |
| FOUP 800(Pa) | use door | use door | door | use door | door |
| FOUP state | gastightness | abnormal | gastightness | abnormal | abnormal |
| | good | gastightness | good | gastightness | gastightness |
| gas pressure value | 600~700 | 350~599 | 600~700 | 350~599 | 350~599 |
| measured Pa (i.e., | | | | | |
| judgement factor) | | | | | |
| Result of judgement | FOUP | door leakage | | shell leakage | |
| (gas leakage rate < | gastightness | | | | |
| 25%) | good | | | | |

Step S40: Judge the gastightness

As shown in the examples in Table 1, the present invention assumes that, for the FOUP 10 to be judged as a good product, the gas leakage rate shall not exceed 25% of the pressure value 800 Pa of the injected gas (i.e., the measured gas pressure value shall not be <600 Pa). Based on this, the following Tests 1 to 3 are carried out:
Test 1: The field shows that the measured gas pressure value is 600~700 Pa (i.e., >600 Pa). It can be determined that the gastightness of the chamber 13 of the FOUP 10 formed by closing the shell 11 with the door 12 is good. That is to say, factors causing serious air leakage from the door 12 (including aging or damage of the sealing rubber strip, deformation of the door, etc.) are excluded, and factors causing serious air leakage from the shell 11 (including aging or damage of the gaskets for screws, check valve components in the inlet/outlet valve ports, etc.) are also excluded. Therefore, the gastightness test is completed, and there is no need to proceed with the door replacement operation in Step S50 below.
Test 2 and Test 3: The columns on the right respectively show that the measured gas pressure values are 350~599 Pa (i.e., <600 Pa). It can be determined that air leakage occurs in the chambers 13 of the FOUP 10 formed by closing the shell 11 with the respective door 12 used in Test 2 and Test 3. Therefore, the door replacement operation in Step S50 below should be carried out respectively.
Step S50: Replace the door with a standard door

In this step, at least one of the third actuator 121 and the fourth actuator 43 shown in FIG. 4 can be used to replace the door 12 on the shell 11 with the standard door 40. The purpose of this step is to determine whether the location of the gastightness defect (or location of leakage) of the FOUP 10 is in the shell 11 or the door 12.

As shown in FIG. 4, after the door 12 on the shell 11 is replaced with the standard door 40, the aforementioned steps S10 to S30 must be repeated to re-establish the specific gas pressure (e.g., 800 Pa) in the chamber 132 enclosed by the shell 11 and the standard door 40 before measuring the judgment factor.
Step S60: Determine the location of leakage

As shown in Table 1 again:
Test 2: The column on the right shows that after replacing the door 12 with the standard door 40, the measured gas pressure value is 600~700 Pa (i.e., ≥600 Pa). It can be known that, after replacing the original door 12 with the standard door 40, the gas pressure in the chamber 13 has changed from the previous leakage state with gas pressure of 350~599 Pa (i.e., <600 Pa, as shown in the left column of Test 2) to a state without leakage (gas pressure at 600~700 Pa, i.e., ≥600 Pa). Accordingly, it can be determined that the location of serious leakage is from the door 12. That is to say, the door 12 may have serious leakage due to aging or damage of the sealing rubber strip 14, or deformation of the door 12. Therefore, Step S70 below should be carried out.
Test 3: The right column shows that after replacing the door 12 with the standard door 40, the measured gas pressure value still remains at 350~599 Pa (i.e., <600 Pa), the same as before the replacement of the door (i.e., the left column of Test 2). It can be known that the location of leakage is not from the door 12, but from the shell 11. That is to say, the shell 11 may have serious leakage due to aging or damage of the gaskets in the screw holes, or the check valves or their components in the gas inlet valve port 113 and gas outlet valve port 112. Therefore, Step S70 below should be carried out.
Step S70: Replace or repair the door or shell

This step can be carried out manually or by automatic machinery. That is, after performing Step S60 above, if it is determined that the location of leakage is from the door 12, then in this step, the door 12 should be replaced or renewed, or the aging or damaged sealing rubber strip 14 on the door 12 should be repaired or renewed, so that the door 12 can restore a good gas-blocking effect after closing the shell 11. If it is determined that the location of serious leakage is from the shell 11, then in this step, the shell 11 should be replaced or renewed, so that the shell 11 can restore a good gas-blocking effect after closing with the door 12. Moreover, after replacing or repairing the door 12 or the shell 11, steps S10 to S70 can be repeated to confirm that the gastightness of the FOUP 10 is good.

In addition, in the second example shown in FIG. 5 and FIG. 6, the gas leakage flow (L/min) is used to replace the gas pressure (Pa) as the judgment factor, and a specific allowable leakage flow in the chamber 13 after the pressurized gas is generated is used as the judgment benchmark (replacing said standard: gas leakage rate <25% of 800 Pa). Then, the above Table 1 and the above steps can be applied when conducting the test to determine the location of leakage and ensure the gastightness yield of the FOUPs 10.

It can be seen that the present invention can further determine the leakage location of the FOUP 10 through said embodiments. Comparing to the prior-art WO2018083312A1 patent, which cannot determine the leakage location of the FOUP according to the technique it teaches, the present invention helps manufacturers to accurately determine the leakage location of the FOUP 10, so that they can replace the parts where the leakage occurs, such as the door 12, the shell 11, or their components. In this way, FOUPs 10 on the production line can be maintained at a good state of gastightness in the most economical way.

Although the invention has been explained in relation to its preferred embodiment, it is to be understood that many other possible modifications and variations can be made without departing from the spirit and scope of the invention as hereinafter claimed.

1. A FOUP gastightness detection device, used to detect the gastightness of a chamber within the FOUP, wherein the FOUP comprises a shell forming the chamber and a door configured to close and seal the chamber, the shell having at least two valve ports capable of controlling the time of gas communication between the chamber and the external environment. The detection device comprises:
a pressure accumulation gas loop, configured to guide gas through the at least one valve port into the chamber to form a closed loop;
a gas sensor, serially disposed in the pressure accumulation gas loop, configured to capture a judgment factor of the gas within the pressure accumulation gas loop to detect the gastightness of the chamber; and
a standard door without leakage factors, movably arranged within the detection device. Specifically, when the gas sensor detects an abnormality in the gastightness of the chamber, the standard door is used to replace the door to judge whether the leakage causing the gastightness abnormality is from the shell or the door.

2. The FOUP gastightness detection device defined in claim 1, wherein the at least two valve ports comprise at least one gas inlet valve port and at least one gas outlet valve port, the pressure accumulation gas loop comprises an intake duct connected between a gas supply end and the at least one gas inlet valve ports, and the detection device further comprises at least one gaslock component configured to seal at least one of the gas outlet valve ports to transform the pressure accumulation gas loop into a closed loop.

3. The FOUP gastightness detection device defined in claim 1, wherein the gas sensor is serially connected between the gas supply end and at least one of the gas inlet valve ports via the intake duct, and the gas sensor is a pressure sensor capable of detecting the pressure value of the gas within the chamber.

4. The FOUP gastightness detection device defined in claim 2, wherein the gas sensor is serially connected between the gas supply end and at least one of the gas inlet valve ports via the intake duct, and the gas sensor is a flow controller capable of detecting the gas flow within the chamber.

5. The FOUP gastightness detection device defined in claim 3, wherein the intake duct further comprises a particulate filter and a pressure reducer serially connected between the gas supply end and the gas sensor.

6. The FOUP gastightness detection device defined in claim 2, wherein the intake duct is communicated with at least one of the gas inlet valve ports via a sealing element, the sealing element is driven by a first actuator to achieve airtight connection and communication with at least one of the gas inlet valve ports, and at least one of the gaslock components is driven by a second actuator to seal at least one of the gas outlet valve ports.

7. The FOUP gastightness detection device defined in claim 1, wherein the at least two valve ports comprise at least one gas inlet valve port and at least one gas outlet valve port, the pressure accumulation gas loop comprises an intake duct and an exhaust duct, the intake duct is connected between a gas supply end and at least one of the gas inlet valve ports, the exhaust duct is connected between at least one of the gas outlet valve ports and an exhaust port, and the detection device further comprises a gaslock component configured to seal the exhaust port to transform the pressure accumulation gas loop a closed loop.

8. The FOUP gastightness detection device defined in claim 7, wherein the gas sensor is serially connected between the exhaust port and at least one of the gas outlet valve ports via the exhaust duct, and the gas sensor is a pressure sensor capable of detecting the pressure value of the gas within the chamber.

9. The FOUP gastightness detection device defined in claim 8, wherein the intake duct further comprises a particulate filter, a pressure reducer, and a flow controller serially connected between the gas supply end and the gas sensor.

10. The FOUP gastightness detection device defined in claim 7, wherein the gas sensor is serially connected between the gas supply end and at least one of the gas inlet valve ports via the intake duct, and the gas sensor is a flow controller capable of detecting the gas flow within the chamber.

11. The FOUP gastightness detection device defined in claim 10, wherein the intake duct further comprises a particulate filter and a pressure reducer serially connected between the gas supply end and the gas sensor.

12. The FOUP gastightness detection device defined in claim 10, wherein the exhaust duct further comprises a pressure sensor serially connected between the exhaust port and at least one of the gas outlet valve ports.

13. The FOUP gastightness detection device defined in claim 1, wherein the standard door and the door are driven by at least one third actuator to replace the door with the standard door.

14. A FOUP gastightness detection method, used to detect the gastightness of a chamber within the FOUP, wherein the FOUP comprises a shell forming the chamber and a door configured to close and seal the chamber, the shell having at least two valve ports capable of controlling the time of gas communication between the chamber and the external environment; the detection method comprises:
filling a gas at a specific pressure through at least one of the valve ports into the chamber to form a closed loop with pressure accumulation, and then measuring a judgment factor of the gas with accumulated pressure within the chamber to detect the gastightness of the chamber;
when an abnormality in the gastightness of the chamber is detected, a standard door without leakage factors is used to replace the door, and the judgment factor measured after gas accumulation is used to judge whether the leakage causing the gastightness abnormality is from the shell or the door.

15. The FOUP gastightness detection method defined in claim 14, wherein the judgment factor is the pressure value of the specific pressure gas accumulated within the chamber.

16. The FOUP gastightness detection method defined in claim 14, wherein the judgment factor is the leakage flow of the specific pressure gas accumulated within the chamber.

17. The FOUP gastightness detection method defined in claim 14, wherein the gas is air, nitrogen, or ultra-pure compressed dry air.
